(19) United States
(12) Patent Application Publication
(10) Pub. No.: US 2016/0323037 A1
(43) Pub. Date: Nov. 3, 2016

(54) ELECTRO-OPTICAL SIGNAL TRANSMISSION

(71) Applicant: HEWLETT PACKARD ENTERPRISE DEVELOPMENT LP, Houston, TX (US)

(72) Inventors: Kevin B. LEIGH, Houston, TX (US); Michael L. SABOTTA, Houston, TX (US); George D. MEGASON, Spring, TX (US)

(21) Appl. No.: 15/108,789

(22) PCT Filed: Jan. 29, 2014
(86) PCT No.: PCT/US2014/013529

§ 371 Date: Jun. 29, 2016

(51) Int. Cl. H04B 10/2575; H04B 10/69; H04B 10/50; H04B 10/079; H04Q 11/00

(52) U.S. Cl. CPC H04B 10/2575; H04B 10/0791; H04Q 11/0005; H04B 10/50; H04B 10/69; H04Q 11/0062; H04Q 2011/0039; H04Q 2011/0041; H04Q 2011/0073

(57) ABSTRACT

Techniques for routing signals through an optical cable are disclosed herein. The system includes a first electrical switch controlled by a first controller to receive a first electrical signal. The system also includes an optical transmitter controlled by a first controller to receive the first electrical signal and convert it into an optical signal and send it through an optical cable. The system further includes an optical receiver controlled by a second controller to receive the optical signal and convert it into a second electrical signal. The system further includes a second electrical switch controlled by a second controller to send the second electrical signal to a receiving device.

### BACKGROUND

Modern datacenters employ optical transceivers and fibers for high bandwidth connections over relatively long distances. Optical transmitters take electrical signals and encode them into optical signals that are carried over optical fibers to optical receivers that reproduce the electrical signals and the information they carry. An optical fiber generally has multiple lanes, each of which carries optical signals. Optical fiber connections are also used to connect different chassis or systems together in a network.

### BRIEF DESCRIPTION OF THE DRAWINGS

Certain examples are described in the following detailed description and in reference to the drawings, in which:

FIG. 1 is a block diagram representing a dynamic electro-optical shuffle (DEOS) system;

FIG. 2 is a block diagram of a DEOS transceiver having an electrical switch and an optical transceiver;

FIG. 3 is a block diagram of a DEOS transceiver having an electrical switch, electrical gearbox and optical transceiver;

FIG. 4 is a block diagram of a DEOS transceiver having an electrical switch, electrical gearbox and optical transceiver in different order;

FIG. 5 is a block diagram illustrating a technique for using two DEOS transceivers and controllers;

FIG. 6 is a block diagram that illustrates how a system topology may be changed using the electro-optical shuffle system;

FIG. 7 is a block diagram that illustrates how a network topology may be changed using the electro-optical shuffle system;

FIG. 8 is a block diagram illustrating how a network topology may be changed in system of four chassis connected together using the electro-optical shuffle system and additional electrical switches; and,

FIG. 9 is a process flow diagram of a method for dynamic electro-optical shuffling.

### DETAILED DESCRIPTION OF SPECIFIC EMBODIMENTS

The present disclosure relates to techniques for routing signals through an optical cable. More specifically, the present disclosure describes an electro-optical transceiver that provides routing capabilities and is referred to herein as a dynamic electro-optical shuffle (DEOS) transceiver. The DEOS transceiver can include an electrical switch coupled to an optical transceiver. The signal path through the optical transceiver can be controlled by controlling the electrical switch. In some examples, two DEOS transceivers can be coupled through an optical cable to create a DEOS link between a transmitting device to the receiving device. The control of the switches at each end of the DEOS link can be coordinated to control the routing path of the data from the transmitting device to the receiving device. Various capabilities can be achieved by coordinating the control of the switches at each end of the DEOS link. For example, the DEOS transceiver can be used in conjunction with over-provisioning an optical cable with extra optical fibers and a built-in failure mechanism that is transparent to the devices coupled by the optical cable. In some examples, the DEOS transceiver can be used to control routing in a network or a data center.

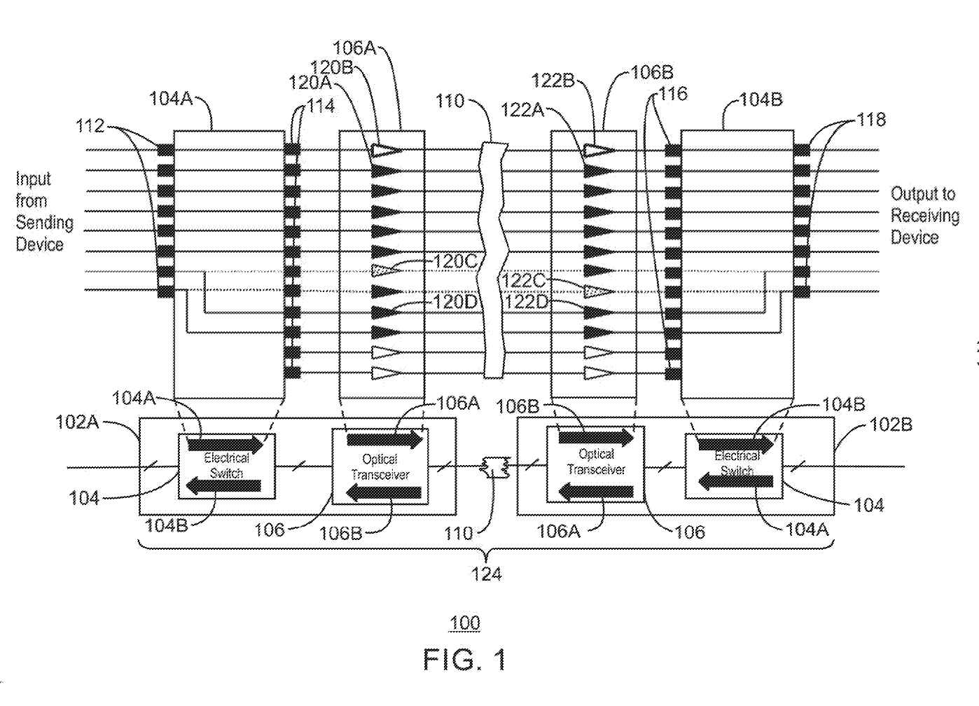

FIG. 1 is a block diagram representing a dynamic electro-optical shuffle (DEOS) system. The DEOS system is generally referred to by the reference number 100 and can be used to transmit data between two or more computing devices.

As shown in FIG. 1, the DEOS system 100 includes two DEOS transceivers 102A and 1028 that are communicatively coupled through an optical cable 110. The two DEOS transceivers 102A and 1028 each includes an electrical switch 104 and an optical transceiver 106. The electrical switches 104 may be electrical crossbar switches or any other suitable switch type. Furthermore, although a single switch is shown, a DEOS transceiver 102A and 1028 may also include two or more switches. For example, the DEOS transceiver 102A may include one transmitter switch 104A for outgoing data transmissions and a second receiver switch 1048 for incoming data transmissions. In FIG. 1, the details of only 104A for 104 in 102A are shown and only 1048 for 104 in 1028 are shown. The optical cable 110 linking DEOS transceivers 102A and 1028 may be composed of multiple fibers allowing multiple lanes of traffic to pass through. A lane comprises a transmit path and a receive path. The optical cable may also be over-provisioned with extra optical fibers and optical transceivers for redundancy. The extra optical transceivers that are not in used may be turned off. The unused and good optical transceivers are referred to as dark transceivers, and the corresponding unused optical fibers are referred to as dark fibers.

Each electrical switch 104 may contain a transmitter switch 104A and a receiver switch 1048. The transmitter switch 104A may contain multiple ports. In some examples, one transmitter switch 104A has two sets of ports 112 and 114 and a receiver switch 1048 also has two sets of ports 116 and 118. In addition, each optical transceiver 106 may actually include multiple optical transmitters 106A and optical receivers 1068. An optical transceiver 106 may also contain circuitry that enables it to detect pre-failure or failed conditions.

In some examples, at a port 112, transmitter switch 104A receives an electrical signal from a sending device. This electrical signal corresponds to data to be sent to a receiving device. Transmitter switch 104A then connects the electrical signal to an optical transmitter 120A via a port 114. The optical transmitter 120A then converts the first electrical signal into an optical signal and transmits the optical signal through an optical cable 110 to a respective optical receiver 122A. The optical receiver of 122A then converts the optical signal back into the second electrical signal and sends the electrical signal to a port 116 of receiver switch 1048. Receiver switch 1048 connects this electrical signal to a corresponding port 118 to complete the path of the electrical signal to the receiving device. A sending device and a receiving device may be a network interface controller (NIC) or a network switch.

As previously mentioned, an optical transceiver 106 may also contain circuitry that enables it to detect pre-failure or failed conditions. In some examples, the DEOS transceiver 102 can be used to provide an optical cable with over-provisioned optical fibers and a built-in failure detection and recovery mechanism that is transparent to the devices coupled by the optical cable. In some examples, the DEOS system may itself be integrated into the optical cable, and is referred to as a DEOS cable 124.

In some examples of the fail-over feature, transmitter switch 104A had initially connected the electrical signal to optical transmitter 120C through corresponding port 114. However, for example, a pre-failure or failed condition was detected on optical transmitter 120C. This pre-failure or failed condition is indicated in FIG. 1 by the broken lines connecting to 120C and 120D. Transmitter switch 104A has rerouted the path of the electrical signal through a corresponding port 114 to an available optical transmitter 120D. Optical transmitter 120D now converts the electrical signal to an optical signal and sends the signal to optical receiver 122D. Optical receiver 122D converts the optical signal into another electrical signal and sends this electrical signal to receiver switch 104B via its corresponding port 116. Receiver switch 104B then connects port 116 to the original port 118 through which the electrical signal had been traveling to the receiving device. In some examples, a similar process may occur when receiver 122C is detected as having a pre-failure or failed condition. In some examples, a similar process may occur when receiver 122C does not detect signal because of an optical fiber path failure condition. In some examples, the signal path selections for the transmitter switch 104A and the receiver switch 104B may be independent.

Because the route of initial electrical signals entering port 112 of transmitter switch 104 and the corresponding second electrical signals of output ports 118 remain constant, the functionality of the DEOS system 100 may be transparent to both the sending device and receiving device.

Furthermore, in some examples, this entire system may reside in a single DEOS cable assembly 124 having two DEOS transceivers 102 at either end. In some examples, the system may have two separate DEOS transceivers 102 connected together via an optical cable 110.

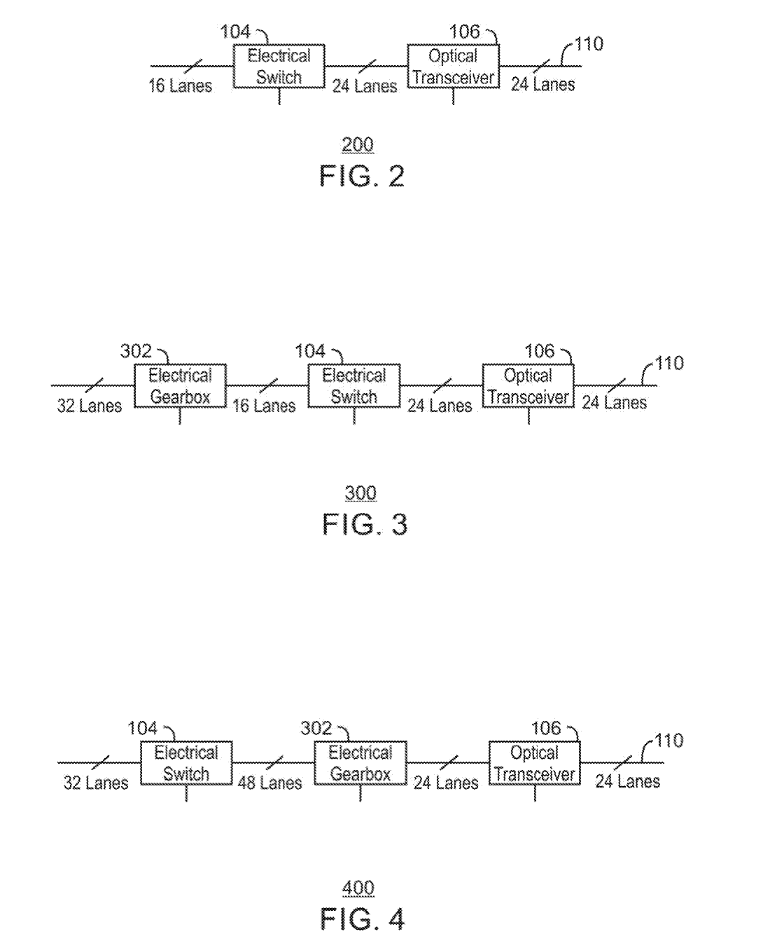

FIG. 2 is a block diagram of a DEOS transceiver having an electrical switch 104 and an optical transceiver 106. This particular configuration of DEOS transceiver 102 in FIG. 2 is generally referred to by the reference number 200.

In the example, electrical switch 104 is connected to optical transceiver 106, which itself is connected optical cable 110. In some examples, an initial 16 electrical signal lanes may be connected to an electrical switch 104. The electrical switch 104 may be connected to optical transmitter by 24 electrical signal lanes, representing 8 extra lanes or 50% over-provisioned for redundancy.

In some examples, the first electrical switch 104 may route these 16 electrical signal lanes to any 16 of the 24 electrical lanes that connect the first electrical switch 104 to optical transmitter 106. In this example, eight optical transmitters and eight optical fibers have been over-provisioned in optical cable 110 to provide a form of redundancy in case of optical transmitter or optical receiver failures. More or fewer over-provisioned fibers may be included depending on the amount of redundancy sought.

FIG. 3 is a block diagram of a DEOS transceiver 102 having an electrical gearbox 302, an electrical switch 104, and an optical transceiver 106. This particular configuration of the DEOS transceiver 102 is generally referred to by the reference number 300.

In this example, an electrical gearbox 302 is connected to an electrical switch 104, which is connected to an optical transceiver 106. The addition of an electrical gearbox 302 communicatively connected to the electrical switch 104 may allow the DEOS transceiver 120 to use faster signaling rates on fewer signal paths.

In this example, the input to the gearbox 302 may be comprised of 32 signal lanes which the gearbox 302 may convert to 16 electrical lanes having signal rates that are twice as fast. In this example, it is still possible to use 8 over-provisioned lanes to achieve the same redundancy as in the previous configuration 200. Thus, 24 total electrical lanes exist between the electrical switch 104 and optical transceiver 106 even though an initial 32 electrical lanes are being routed. In this example, the electrical switch would have to operate at a higher speed than the switch in configuration 200.

FIG. 4 is a block diagram of a DEOS transceiver having an electrical switch 104, an electrical gearbox 302 and an optical transceiver 106 in a different order. The DEOS transceiver 102 configuration is generally referred to by the reference number 400.

In this example, the electrical gearbox 302 and the electrical switch 104 are ordered such that the electrical switch 104 is connected to the electrical gearbox 302, which is connected to the optical transceiver 106. The Optical transceiver 106 is also connected to an optical cable 110.

In some examples, 32 electrical lanes are input into electrical switch 104, which is communicatively connected to electrical gearbox 302 via 48 lanes. The electrical gearbox 302 is communicatively connected to optical transmitter 106 via electrical 24 lanes. By arranging the electrical switch and the electrical gearbox as shown in this example, the electrical switch 104 may operate at an incoming data rate while the optical transceiver 106 may operate at twice the incoming data rate. The gearbox in this example needs to convert higher number of lanes in comparison to configuration 300.

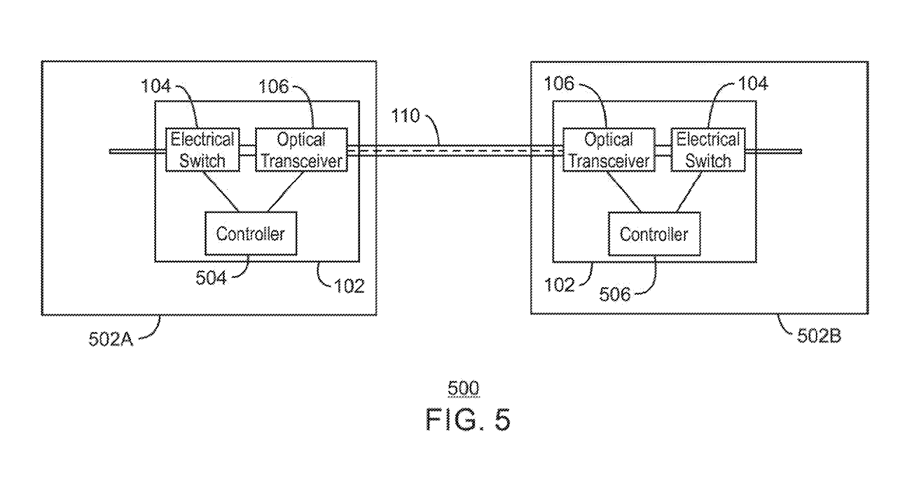

FIG. 5 is a block diagram illustrating a technique for using two DEOS transceivers 102 and controllers 504 and 506. The DEOS system operation as described by FIG. 5 is generally referred to by the reference number 500.

As discussed above, fiber optic cables include multiple lanes through which data signals pass. The number of lanes in a high lane-count optical transceiver is typically in the several dozens. When an optical transceiver malfunctions, a failed connection causes service outage. It is a common practice to replace the transceiver without replacing the corresponding optical cable, if the cable is not at fault. Identifying and replacing these failed high lane-count optical transceivers not only takes a long time, but is also expensive. This is especially true when replacing a high lane-count transceiver due to the malfunction of a single lane. Examples described herein provide a fail-over technique that avoids service outages due to some number of transceivers failures or fiber connection failures and makes such replacement unnecessary.

For example, two systems 502A and 502B may be connected via an optical cable 110 that joins two DEOS transceivers 102 operatively connected to each system as in FIG. 5. In each DEOS transceiver 102, an electrical switch 104 and optical transceiver 106 may be connected to each other and a controller 504 or 506. For purposes of illustration, controller 504 is contained within the DEOS transceiver 102 of system 502A and controller 506 is contained within the DEOS transceiver 102 of system 502B. Although not shown, these controllers may also be operatively connected directly or through a network.

As shown in FIG. 5, controllers 504 and 506 are each operatively connected to their respective electrical switch 104 and optical transceiver 106. In some examples, controllers 504 and 506 may identify which particular optical transmitters or optical transceivers to use at any given time. Controllers 504 and 506 may also power off the optical transmitter and optical receiver when they are not in use and turn them back on before using them again.

In some examples, controllers 504 and 506 coordinate to control electrical switches 104 and optical transceivers 106. In some examples, controllers 504 and 506 coordinate so that electrical switches 104 may route signals around optical transceivers displaying pre-failure or failed conditions. In determining whether a dark optical transmitter 120D should be used, first controller 504 may communicate with second controller 506 via control signals sent through optical cable 110. In some examples, these may be in-band control signals that may be transmitted using a low-speed signal modulated with high-speed signals. In some examples, the in-band control signals may be transmitted using different wavelengths. In a further example, the control signals are side-band control signals transmitted on an independent channel. In some examples, one purpose of the DEOS system 500 is to preserve the lifespan of the extra optical transceivers 106 by turning them off. In these examples, the respective controller 504 or 506 may turn on the dark optical transceiver 106 when an active optical transmitter or optical receiver within an optical transceiver 106 begins to fail due to lifetime reliability. In some examples, a benefit of keeping dark optical transceivers 106 off when not in use may be to prevent eye injuries during when the optical cables are disconnected, for example, during repair. In some examples, the purpose of the DEOS system 500 may be to detect and recover from an optical fiber failure, where a dark transceiver 106 may be turned on and an over-provisioned optical fiber within optical cable 110 used when needed.

In some examples, control signals are passed back and forth through optical cable 110 between optical transceivers 106. For example, when a pre-failure condition is detected by controller 504, controller 504 causes a signal to be sent by optical transceiver 106 over optical cable 110 to optical transceiver 106 to communicate the pre-failure condition to controller 506. This communication also includes a request to controller 506 to change the optical signal path to an available optical fiber of over-provisioned optical cable 110. Controller 506 then sends an acknowledgment to change the optical signal path to controller 504. When controller 504 receives this acknowledgment, both controllers 504 and 506 change the optical signal path to utilize the same selected over-provisioned optical cable and operation resumes to normal.

In some examples, system 500 may be contained within a single integrated DEOS cable 124. In this example, a DEOS transceiver may be integrated into each connector end of the DEOS cable 124. In some examples, the optical transmitters and optical receivers within the cable may be capable of failure detection. In some examples, a passive optical cable may be modularly attached to the DEOS transceivers 102 by using optical connector on each end of the optical cable. In yet another example, there may be multiple optical connectors and cables between two DEOS transceivers 102.

In some examples, the control signals may be in-band control signals sent through cable 110 between optical receivers 106. In another example, the control signals may be side-band control signals, sent over an independent optical lane between optical receivers 106. In yet another example, the control signals may use a dedicated electrical path for short cables. For example, a heartbeat control signal may be sent between optical transceivers 106. The absence of the heartbeat signal on either optical transceiver 106 may indicate a failure or pre-failure condition. In this case, first controller 504 and second controller 506 may communicate the failure or pre-failure condition via an independent channel and cause their corresponding electrical switches 104 to connect to another available optical transmitter 106A and optical receiver 1068. After the networking protocol layers retransmit information due to signal loss during the channel change-over, the signal from the sending device may be sent through this new route to the receiving device.

In some examples, the controllers 504 and 506 may communicate and reroute the signal path in a host-transparent manner. Thus, after operation resumes to normal, network data loss that occurred during the process may be quickly and easily handled by networking layers.

In some examples, the rerouting may be host-aware. In this example, the hosts would be aware of the intermediate path change taking place and wait until the path change is finished before resuming the sending or receiving of data. For example, in the Ethernet context, flow control standard protocols may be used. In the system configuration context, other common methods may be used to make the host wait.

In some example, the controllers 504 and 506 may be parts of a sending device controller, a receiving device controller, or a system controller. In some examples, the controllers 504 and 506 may be communicatively coupled to other system controllers.

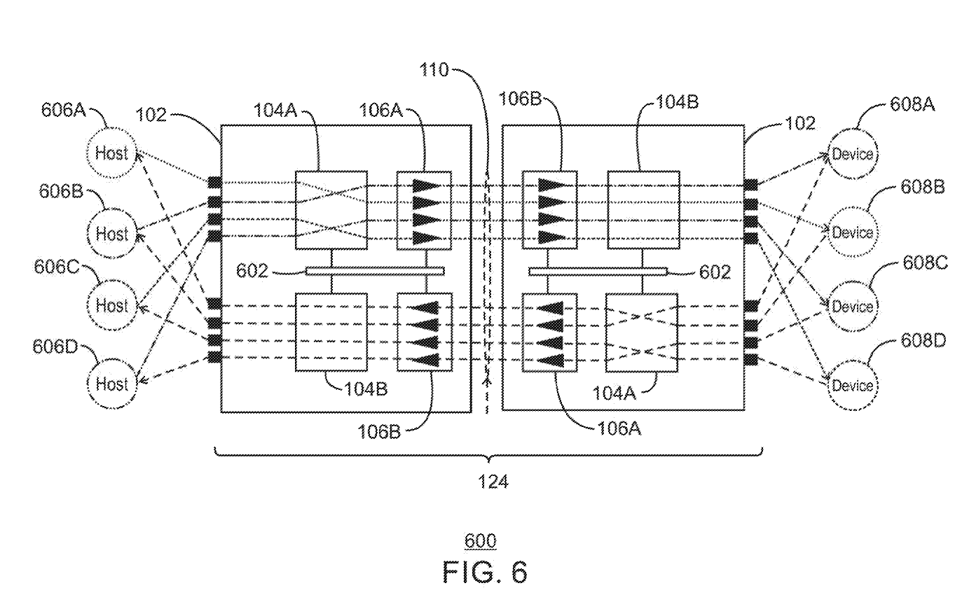

FIG. 6 is a block diagram that illustrates how a system topology may be changed using the electro-optical shuffle system. The system topology of FIG. 6 is generally referred to by the reference number 600.

In the example shown in system topology 600, four hosts 606A through 606D are connected to four devices 608A through 608D via two DEOS transceivers 102 that are themselves linked together by an optical cable 110. In some examples, any device port can be connected to any host port via a DEOS cable 124. Each DEOS transceiver 102 may include two electrical switches 104A and 1048, an optical transmitter 106A and an optical receiver 1068.

The switches 104A and 1048, optical transmitters 106A and optical receivers 1068 are connected to management mechanisms 602. The management mechanisms 602 may perform functions similar to the controllers 504 and 506 as described in 500. The management mechanisms 602 may, for example, allow system administrators to change system topology remotely. In this example, the switching functionality of electrical switches 104A and 1048 is controlled by management mechanisms 602. In some examples, the electrical switching may be done on the transmit side for ease of management. In other examples, this switching may be done on the receiving side. In some examples, the electrical switching may be done on both sides. In some examples, one of the hosts may be managing the system topology. In some examples, this may be done through the switch ports. In some examples, the management signals are sent and received through a separate side channel.

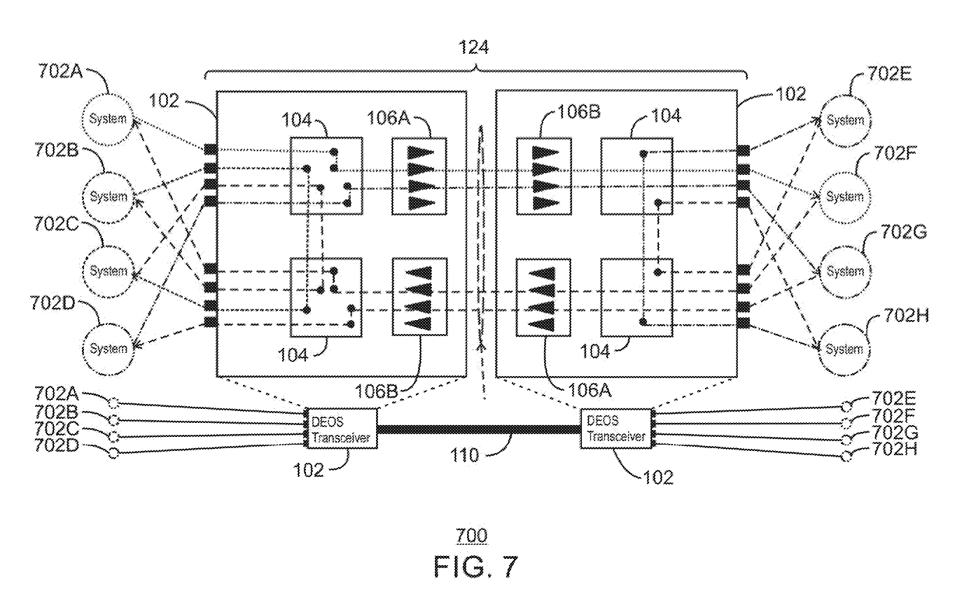

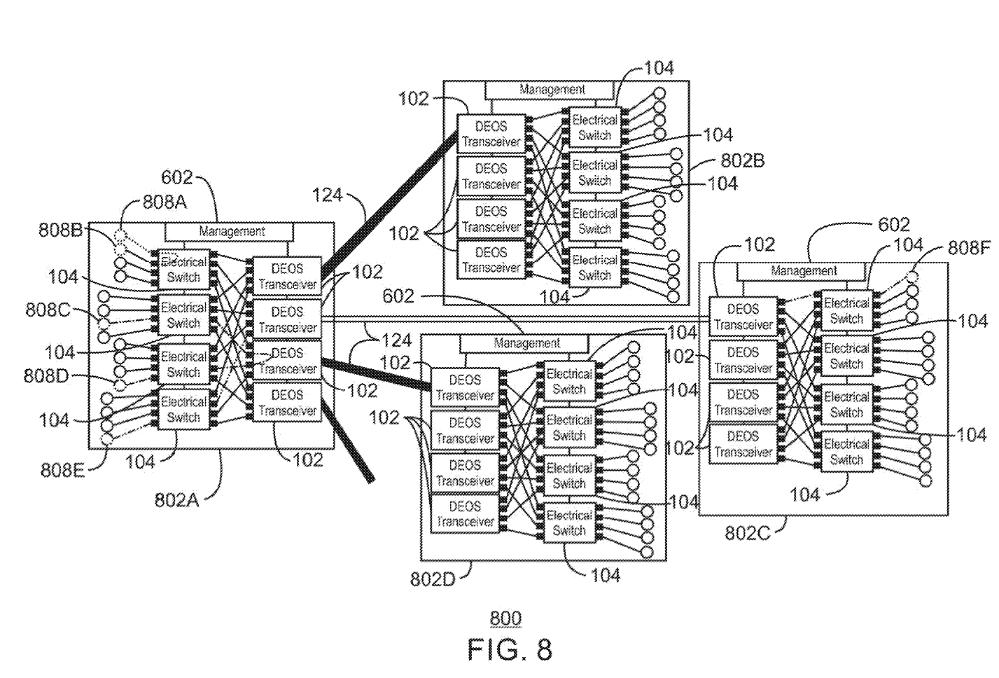

FIG. 7 is a block diagram that illustrates how a network topology may be changed using the electro-optical shuffle system. The network topology is generally referred to by the reference number 700.

In some examples, eight systems 702A through 702H are connected through two DEOS transceivers 102, which are themselves connected via optical cable 110. In some examples, the electrical switches within each DEOS transceiver 102 may also be operatively connected. In some examples, electrical switches 104 may be multiplexed output type switches or multiplexed input type switches. For example, a multiplexed input switch 104 may be able to receive electrical signals from multiple sources. In some examples the sources may be a sending device and another electrical switch. In some examples, the sources may be multiple switches. In some examples, a multiplexed output switch 104 may be able to send electrical signals to multiple destinations. In some examples, the destinations may be another switch and a system. In some examples, the destinations may be multiple switches or systems.

As shown in network topology 700, a system may connect to any other system on the same side or opposite sides of a DEOS cable 124. For example, system 702A connects across DEOS cable 124 to system 702F. System 702B may connect to system 702C without going through the DEOS cable 124, instead connecting through two electrical switches 114 within a single DEOS transceiver 102.

As mentioned above, fiber optic cables may be used in a network environment. In some examples, these networks may have high lane-count links, especially between inter-switch links. In these examples, an advantage of using DEOS connections in 700 is that traditional redundant links that require redundant switches can be avoided. In some examples, the system of 700 may use relatively inexpensive optical transceivers 106 to achieve a relatively reliable connection. In these examples, an additional benefit of system 700 in the network setting is the use of cheaper optical transceivers 106 to reduce costs.

FIG. 8 is a block diagram illustrating how a network topology may be changed in a system of four chassis connected together using the electro-optical shuffle system and additional electrical switches. The system of chassis is generally referred to by the reference number 800.

In the example of FIG. 8, four chassis 802A through 802D are connected to one another via DEOS cables 124. The chassis may provide their enclosed server systems with power, cooling, storage and networking services that may be shared among the systems. In some examples, the chassis may be in the same server room or warehouse. In some examples, the chassis may be in more remote locations of a building, or in different buildings. In some examples, the server systems 808A through 808F may be blade servers that are optimized to minimize use of physical space and energy. Traditional protocol-specific switches, such as Fibre Channel (FC) switches, have varying bandwidth and lane counts per port. Signals from NICs are fixed routed to switch bay connectors in the blade server environment. These fixed-routed signal paths cannot be changed to use fewer high-band bandwidth switches. Consequently, multiple switches are still commonly used. To enable efficient deployment, different individual switch designs are commonly chosen and used at the expense of multiple designs or stranded ports.

In some examples, each chassis may have four DEOS transceivers 102 connected to each other and to four electrical switches 104. The DEOS transceivers 102 and electrical switches 104 of each chassis may also be connected to management mechanisms 602. Connected to the electrical switches 104, are a group of systems, of which 808A through 808F are a few examples in FIG. 8. These systems may be server systems, for example, blade servers. A system may connect to any other system port across the DEOS cables, in this example using additional electrical switch stages 104 between the systems and the DEOS cables.

In some examples, multiple designs may be used. For example, in FIG. 8, system 808A is connected to system 808B via a single electrical switch 104 of chassis 802A. System 808C is connected to system 808D via a route that includes two electrical switches 104 joined by a DEOS transceiver 102, all within chassis 802A. System 808E of chassis 802A may be connected to system 808F through the electrical switch 104 and DEOS transceiver 102 of chassis 802A, a DEOS cable 124 that connects chassis 802A and chassis 802C, and a DEOS transceiver 102 and electrical switch of chassis 802C. Management mechanisms 602 may allow the system administrators to change switch designs remotely.

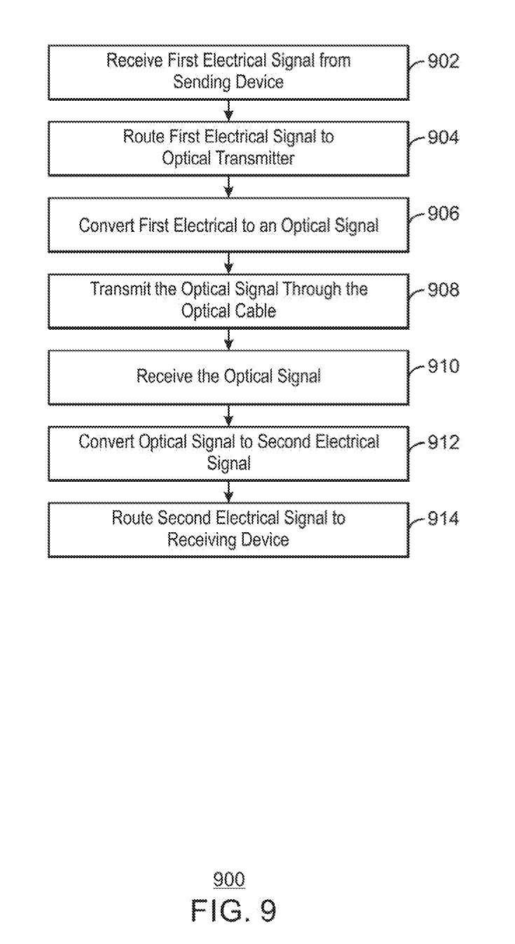

FIG. 9 is a process flow diagram of a method for dynamic electro-optical shuffling. The DEOS method is generally referred to by the reference number 900. At step 902, the method 900 begins with the receiving of a first electrical signal from a sending device. In some examples, the first electrical switch 104 receives a first electrical signal from a sending device. This first electrical signal may be received, for example, from one of eight bidirectional channels connected to first electrical switch 104A.

At step 904, the method 900 continues by routing the first electrical signal to an optical transmitter. In some examples, the first electrical switch 104 routes the first electrical signal to an optical transmitter 120A. In routing the electrical signal, for example, the first electrical switch 104A may communicate with first controller 504.

At step 906, the method continues by converting the first electrical signal to an optical signal. In some examples, an optical transmitter 120A converts the first electrical signal into an optical signal.

At step 908, the method continues by sending the optical signal through the optical cable 110. In some examples, an optical transmitter 120A sends the optical signal through optical cable 110. In some examples, optical cable 110 may be over-provisioned with extra fibers.

At step 910, the optical signal is received. In some examples, an optical receiver 122A may receive the optical signal.

At step 912, the optical signal is converted to a second electrical signal. In some examples, optical receiver 122A converts the optical signal into a second electrical signal.

At step 914, the method continues by routing a second electrical signal to the receiving device. In some examples, this electrical signal is received by a second electrical switch 1048. The second electrical switch 1048 may communicate with a second controller 506 to determine which electrical transmitters on second electrical switch 1048 correspond with the receiving device.

In some examples, the method of 900 is accomplished transparently to both the sending device and the receiving device. In some examples, the method of 900 is performed when the first controller or the second controller detect a pre-failure or failure condition on an optical fiber or optical transceiver.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A system, comprising:
a first electrical switch to receive a first electrical signal from a sending device, the first electrical signal corresponding to data to be sent to a receiving device, the first electrical switch controlled by a first controller;
an optical transmitter to receive the first electrical signal from the first electrical switch, convert the first electrical signal to an optical signal and transmit the optical signal through an optical cable, the optical transmitter controlled by the first controller;
an optical receiver to receive the optical signal transmitted through the optical cable and convert the optical signal to a second electrical signal, the optical receiver controlled by a second controller; and
a second electrical switch to receive the second electrical signal from the optical receiver and send the second electrical signal to the receiving device, the second electrical switch controlled by a second controller;
wherein the first controller and the second controller coordinate to control a routing path of the data from the sending device to the receiving device.

2. The system of claim 1, wherein:
the optical cable comprises over-provisioned fibers; and,
wherein the first and second controller power off the optical transmitter and optical receiver when they are not in use and turn them back on before using them.

3. The system of claim 1, wherein the first and second electrical switches are multiplexed.

4. The system of claim 1, wherein the first controller sends a signal to the second controller to control the routing path.

5. The system of claim 1, wherein the first controller and the second controller coordinate to control the routing path in response to a request from a management mechanism to change a system topology.

6. The system of claim 1, wherein the first controller and the second controller coordinate to control the routing path in response to a request from a management mechanism to change a network topology.

7. The system of claim 1, wherein the first electrical switch, the second electrical switch, the first controller, the second controller, the optical transmitter and the optical receiver are parts of a single cable assembly.

8. The system of claims 1, wherein the first electrical switch, the second electrical switch, the first controller, the second controller, the optical transmitter and the optical receiver are integrated into a system.

9. A cable, comprising:
one end of the cable comprising a first electrical switch to receive a first electrical signal from a sending device, the first electrical signal corresponding to data to be sent to a receiving device;
an optical transmitter to receive the first electrical signal from the first electrical switch, convert the first electrical signal to an optical signal and transmit the optical signal through an optical cable, the first electrical switch and the optical transmitter controlled by a first controller; and
another end of the cable comprising an optical receiver to receive the optical signal transmitted through the optical cable and convert the optical signal to a second electrical signal and transmit the second electrical signal;
a second electrical switch to route the second electrical signal from the optical receiver and send the second electrical signal to the receiving device, the second electrical switch and the optical receiver controlled by a second controller;
wherein the first controller and the second controller coordinate to control a routing path of the data from the sending device to the receiving device.

10. The cable of claim 9, wherein:
the optical transmitter and optical receiver are capable of failure detection.

11. The cable of claim 9, wherein the first controller and the second controller coordinate transparently with respect to both the sending device and the receiving device.

12. The cable of claim 9, wherein the first controller sends a signal to the second controller to control the routing path.

13. A method, comprising:
receiving, via a first switch, a first electrical signal from a sending device, the first electrical signal corresponding to data to be sent to a receiving device, the first electrical switch controlled by a first controller;
routing the first electrical signal to an optical transmitter;
converting, via the optical transmitter, the first electrical signal to an optical signal;
transmitting the optical signal through an optical cable;
receiving the optical signal transmitted through the optical cable at an optical receiver;
converting the optical signal, via the optical receiver, to a second electrical signal; and,
routing, via a second switch, the second electrical signal to the receiving device, the second electrical switch controlled by a second controller,
wherein the first controller and the second controller coordinate to control a routing path of the data from the sending device to the receiving device.

14. The method of claim 13, wherein the first controller and the second controller coordinate to control the routing path in response to detecting a failure or pre-failure condition.

15. The method of claim 13, wherein the first controller and the second controller control the routing path transparently to the sending device and the receiving device.
